(19) United States
(12) Patent Application Publication
(10) Pub. No.: US 2018/0231173 A1
(43) Pub. Date: Aug. 16, 2018

(54) Yoke For A Support Stand

(71) Applicant: Guitar Center, Inc., Westlake Village, CA (US)

(72) Inventor: Robin Richard Slaton, Fort Collins, CO (US)

(73) Assignee: Guitar Center, Inc., Westlake Village, CA (US)

(21) Appl. No.: 15/892,281

(22) Filed: Feb. 8, 2018

Related U.S. Application Data
(60) Provisional application No. 62/458,919, filed on Feb. 14, 2017.

(51) Int. Cl. F16M 11/04; F16B 2/10; F16M 11/28; G10G 5/00

(52) U.S. Cl. CPC F16M 11/041; G10G 5/00; F16M 11/28; F16B 2/10

(57) ABSTRACT

A yoke for a support stand having a support member first end disposed a distance from a support member second end, an arm extending part of the distance between the support member first end and support member second end in an arm first position, and a springing element coupled between the support member first end and the arm first end to which the arm rotationally responds to automatically return the arm toward to the arm first position to retain an object in the yoke.

This United States Non-Provisional Patent Application claims the benefit of U.S. Provisional Patent Application No. 62/458,919, filed Feb. 14, 2017, hereby incorporated by reference herein.

### I. BACKGROUND

Support stands often include yokes that do not include a closure to retain a supported object within the yoke, or the yolk includes a closure that does not readily close to retain the supported object nor readily opens to release the supported object.

There would be an advantage in a yoke for a support stand which provides a closure which can be readily positioned in an open condition to receive a supported object, such as a musical instrument, and returns to a closed condition to retain the supported object in the yoke.

### II. SUMMARY OF THE INVENTION

A broad object of particular embodiments of the invention can be to provide a yoke including one or more of: a support member having a support member first end disposed a distance from a support member second end, an arm extending at least part of the distance between the support member first end and the support member second end, where an arm first end rotatably couples to the support member first end to provide a rotationally positionable arm second end, and a springing element coupled between the support member first end and the arm first end which upon rotation of the arm from an arm first position to an arm second position, upon release, returns the arm toward the arm first position.

Another broad object of particular embodiments of the invention can be to provide a method of making a yoke including one or more of: configuring a support member to dispose a support member first end a distance from a support member second end, rotatably coupling an arm first end to the support member first end to provide an arm second end rotationally positionable to an arm first position with the arm extending at least part of the distance between the support member first and second end, and coupling a springing element between the support member first end and the arm first end, the arm rotationally responsive to the springing element upon release to move the arm toward an arm first position from an arm second position.

Another broad object of particular embodiments of the invention can be to provide a method of using a yoke including one or more of: obtaining a yoke including: a support member having a support member first end disposed a distance from a support member second end, an arm extending at least part of the distance between the support member first end and support member second end, the arm having an arm first end rotatably coupled to the support member first end to provide a rotationally positionable arm second end, and a springing element coupled between the support member first end and the arm first end to which the arm is rotationally responsive; forcibly urging the arm to move away from the arm first position, disposing a supported object within the enclosed interior of the support member; and releasing the arm from the forcible urging which arm returns toward the arm first position.

Naturally, further objects of the invention are disclosed throughout other areas of the specification, drawings, photographs, and claims.

### III. A BRIEF DESCRIPTION OF THE DRAWINGS

FIG. 1 is a perspective view of a particular embodiment of a yoke.

FIG. 2 is an exploded view of a particular embodiment of a yoke.

FIG. 3 is a front view of a particular embodiment of a yoke.

FIG. 4 is a back view of a particular embodiment of a yoke.

FIG. 5 is a first side view of a particular embodiment of a yoke.

FIG. 6 is a second side view of a particular embodiment of a yoke.

FIG. 7 is a top view of a particular embodiment of a yoke.

FIG. 8 is a bottom view of a particular embodiment of a yoke.

FIG. 9 is a perspective view of a particular embodiment of a yoke coupled to a support stand.

FIG. 10 is a front view of a particular embodiment of a yoke coupled to a support stand

FIG. 11 is a back view of a particular embodiment of a yoke coupled to a support stand.

FIG. 12 is a first side view of a particular embodiment of a yoke coupled to a support stand.

FIG. 13 is a second side view of a particular embodiment of a yoke coupled to a support stand.

FIG. 14 is a top view of a particular embodiment of a yoke coupled to a support stand.

FIG. 15 is a bottom view of a particular embodiment of a yoke coupled to a support stand.

FIG. 16 is an exploded view of a particular embodiment of a yoke coupled to a support stand.

FIG. 17 is a top view of a particular embodiment of a mast first portion.

FIG. 18 is a side view of a particular embodiment of a mast first portion.

FIG. 19 is a top view of a particular embodiment of a second support member.

FIG. 20 is a bottom view of a particular embodiment of a second support member.

FIG. 21 is a first side view of a particular embodiment of a second support member.

FIG. 22 is a second side view of a particular embodiment of a second support member.

FIG. 23 is a front view of a particular embodiment of a second support member.

FIG. 24 is a back view of a particular embodiment of a second support member.

FIG. 25 is a perspective view of a particular embodiment of a plurality of yokes coupled to a support stand.

FIG. 26 is a perspective view of another particular embodiment of a plurality of yokes coupled to a support stand.

FIG. 27 is a perspective view of a particular embodiment of a method of using a yoke coupled to a support stand.

### IV. DETAILED DESCRIPTION OF THE PREFERRED EMBODIMENTS

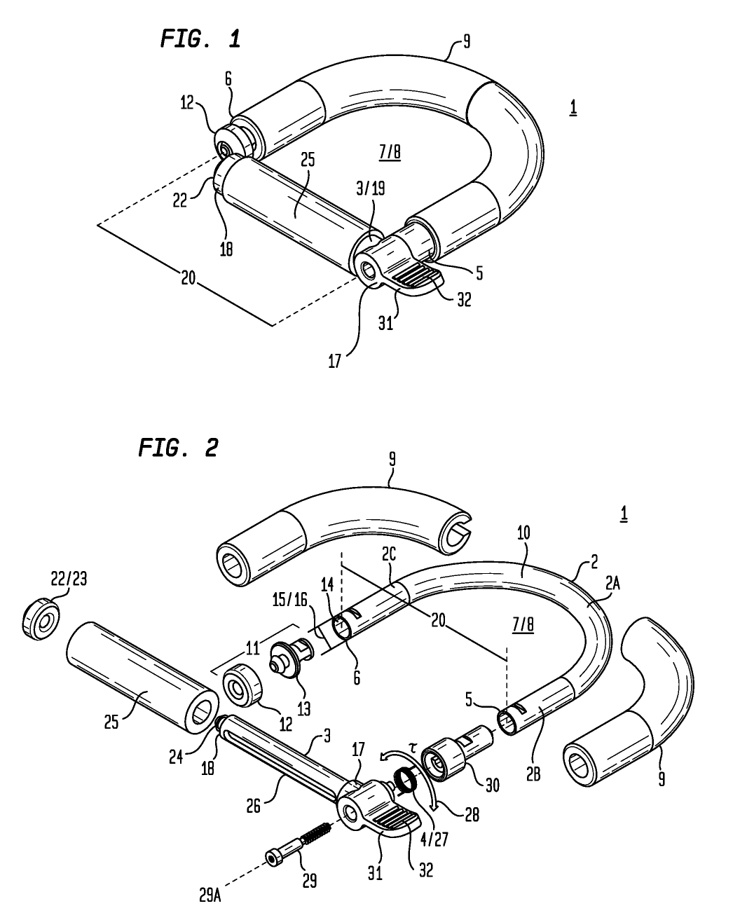

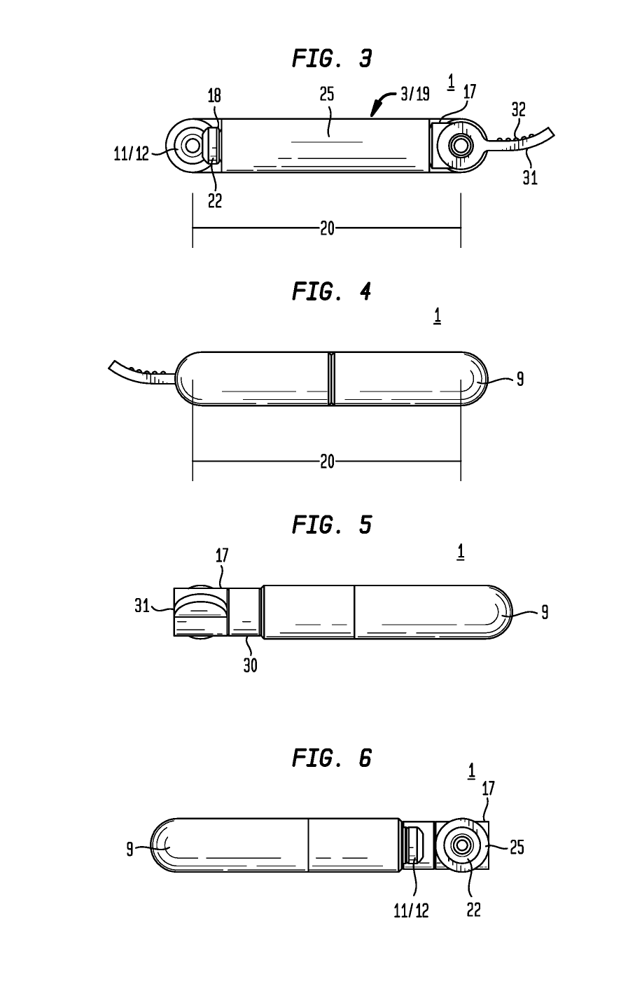

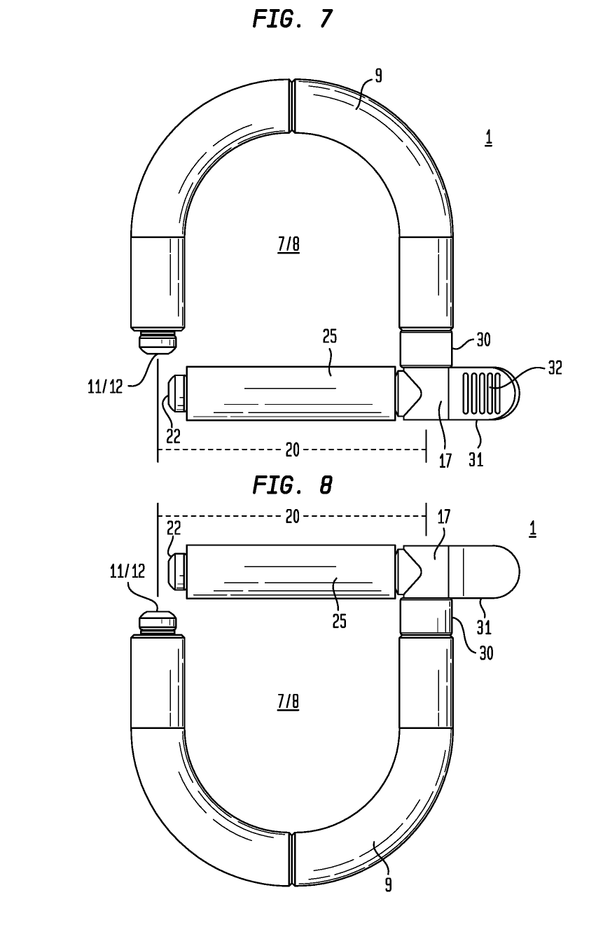

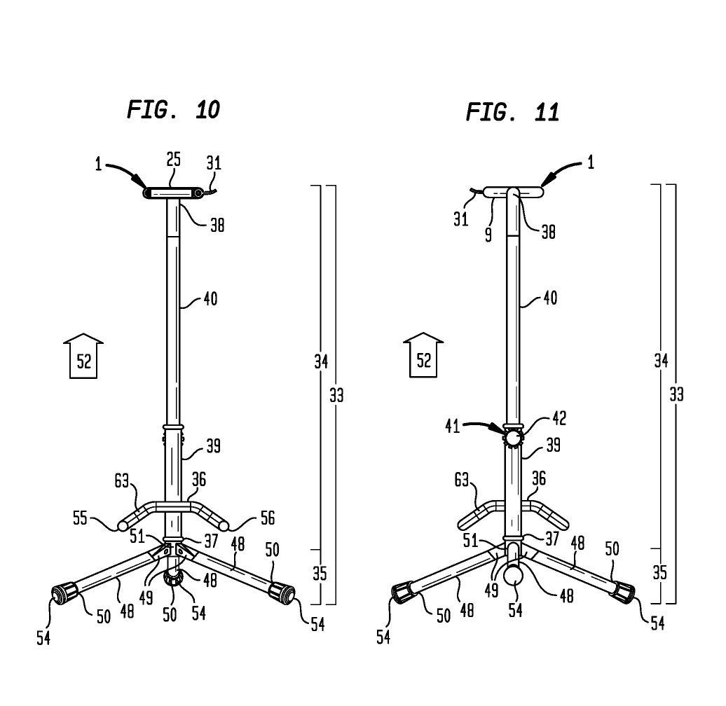

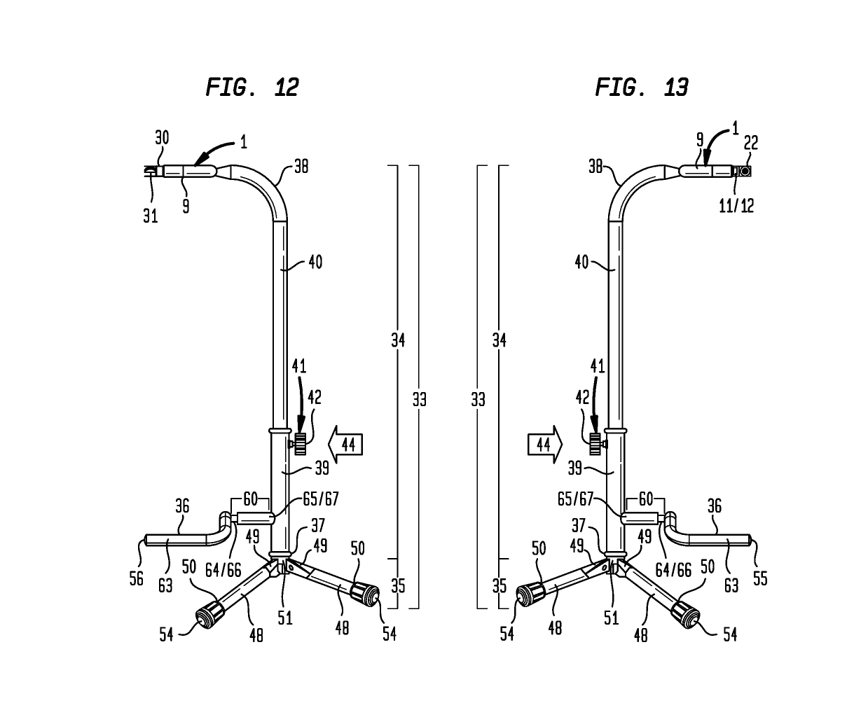

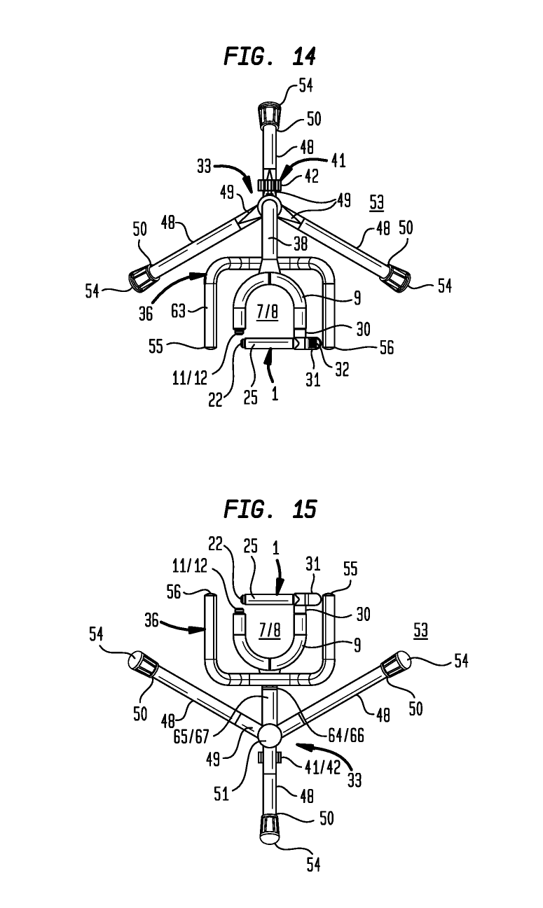

Referring generally to FIGS. 1 through 27, which illustrate particular embodiments of a yoke (1), which can, but need not necessarily, be coupled to or further include a support stand (33) operable to retain a supported object (21), such as a musical instrument.

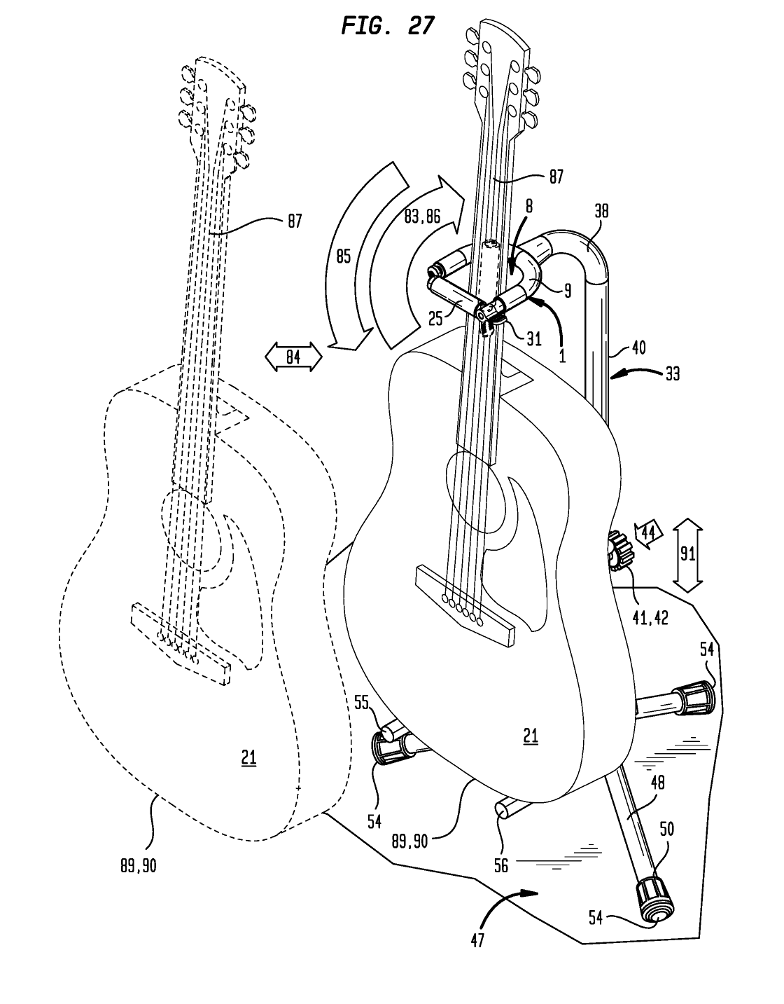

Now referring primarily to FIGS. 1 through 8, embodiments of the yoke (1) can include one or more of: a support member (2), an arm (3), and a springing element (4)(as shown in the example of FIG. 2). The support member (2) can be configured to dispose a support member first end (5) a distance (20) from a support member second end (6). The support member (2) can include a first portion (2A) disposed between outwardly extending second and third portions (2B)(2C) which correspondingly terminate in the support member first end (5) and the support member second end (6)(a shown in the example of FIG. 2). The first portion (2A) can include any of a wide variety of configurations including as examples: a linear configuration or an arcuate configuration, or combination thereof, from which the second and third portions (2B)(2C) can outwardly extend to define a recess (7) or interior space (8) which can, as one example, receive an object (21), such as the neck (87) of a musical instrument (21)(as shown in the example of FIG. 27). The support member (2) can comprise or consist of: solid or tubular metal, metal alloys, polymeric material, plastic, plastic-like material, acrylic, polyamide, polyester, polypropylene, polyvinyl chloride, silicone-based materials, wood, or the like, or combinations thereof.

Again, referring primarily to FIGS. 1 through 8, particular embodiments can, but need not necessarily, include a support member pad (9) coupled to the support member (2). The support member pad (9) can be removably coupled to the support member (2), to completely surround the exterior surface (10) of the support member (2), be permanently coupled to the support member (2), coupled to a portion of the support member (2), or be configured as a sleeve coupled in portions to the length of the support member (2) (as shown in the example of FIGS. 1 and 2). The support member pad (9) can comprise or consist of: a foam, a plastic, a viscoelastic polymer, or any of a wide variety of pliable or pliant materials.

Now referring primarily to FIG. 2, embodiments of the support member (2) may also include a support member end cap assembly (11) coupled to the support member second end (6). The support member end cap assembly (11) can, but need not necessarily, be configured as two pieces to allow a press-fit coupling of the support member end cap assembly (11) to the support member second end (6). By way of illustration, FIG. 2 shows a support member end cap assembly (11) including a cap (12) and a press-fit body (13). The press-fit body (13) can be coupled to the support member second end (6) by forcibly urging the press-fit body (13) into the interior space (14) defined by the support member (2), where the diameter (15) of the press-fit body (13) can be generally equal to the diameter (16) of the interior space (14) of the support member (2). The cap (12) can then be pressingly matingly engaged to the press-fit body (13).

Now referring primarily to FIGS. 1 through 8 and 27, particular embodiments can further include an arm (3) coupled to the support member (2). The arm (3) can have an arm first end (17) rotatably coupled to the support member first end (5) and an arm second end (18) rotationally positionable to a first arm position (19) extending at least part of the distance (20) between the support member first end (5) and the support member second end (6). Further, the arm (3) can extend at least a distance greater than the difference between the distance (20) between the support member first end (5) and the support member second end (6) less the width of the object (21) to be placed in the enclosed interior (8) of the support member (2). The arm (3) can comprise a solid or tubular member comprised or consisting of: metal, metal alloys, polymeric material, plastic, plastic-like material, acrylic, polyamide, polyester, polypropylene, polyvinyl chloride-based materials, silicone-based materials, wood, or the like, or combinations thereof.

Now referring primarily to FIG. 2, the arm (3) can further include an arm end cap (22) configured to matingly engage, threadingly engage, or fixedly adhere to the arm second end (18), or the like. By way of example, FIG. 2 shows an arm end cap (22) having a configuration which can matingly engages the arm second end (18) by press-fit of the arm end cap (22) configured as a female connector (23) over the arm second end (18) configured as a male connector (24). For purposes of this description, a male connector and a female connector can generally be described as a pair of connectors configured to matingly engage, where the female connector is configured to receive and hold the male connector (24).

Again, referring primarily to FIG. 2, in further particular embodiments, an arm pad (25) can be coupled to the arm (3). The arm pad (25) can be removably coupled, permanently coupled to the arm (3), or coupled to a portion of the arm (3), or configured as a sleeve disposed over the length of the arm (3), or the like. The arm pad (25) can comprise or consist of: foam, plastic, viscoelastic polymer, or other pliable or pliant material.

Again, referring primarily to FIGS. 2 and 27, particular embodiments can further include a springing element (4) coupled between the support member first end (5) and the arm first end (17). The arm (3) can be rotationally responsive to the springing element (4) to rotate the arm (3) toward the arm first position (19) extending at least part of the distance (20) between the support member first end (5) and the support member second end (6). The arm (3) can be rotationally responsive to forcible urging to move away from the arm first position (19). The springing element (4) can, but need not necessarily, comprise a torsion spring (27) which receives an amount of torque (28) upon rotation of the arm (3) away from the arm first position (19). This example is not intended to preclude other forms of the springing element (4), such as, resilient elastic couplings comprised of elastomers of natural or synthetic polymers or spring steel which deform to allow rotation of the arm (3) away from the arm first position (19) and return toward the nondeformed condition to correspondingly return the arm (3) toward the arm first position (19). As to particular embodiments, the torsion spring (27) can be contained inside a connector element (30) coupled to the arm first end (17). A mechanical fastener (29) can be inserted through the arm second end (18), the torsion spring (27) and fasten to the connector element (30). The mechanical fastener (29) can define the rotation axis (29A) about which the arm (3) rotates.

Again, referring primarily to FIGS. 1 through 8, particular embodiments, can, but need not necessarily, also include a lever (31) which extends radially outward of the arm first end (17) upon which a force can be applied. Forcible urging of the lever (31) can generate an amount of torque (28) to rotate the arm (3) from the arm first position (19). The lever (31) can, but need not necessarily, include textured surface elements (32) to increase frictional engagement with the lever (31) to generate the amount of torque (28) to rotate the arm (3) from the first arm position (19).

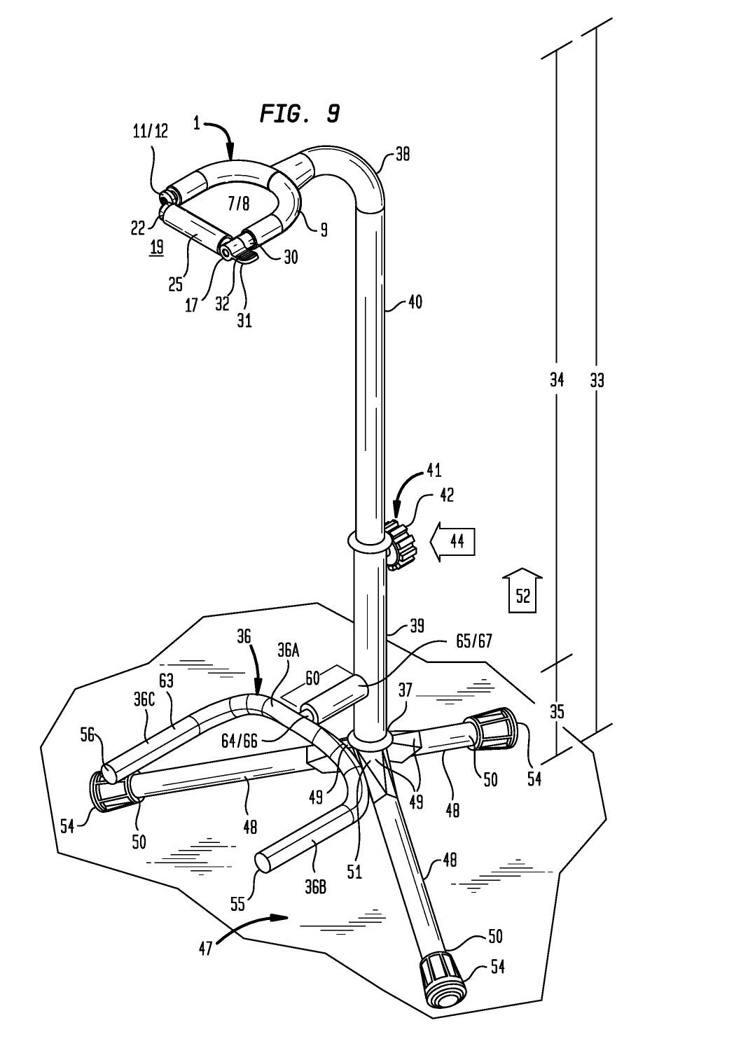

Now referring primarily to FIGS. 9 through 27, particular embodiments can further include a support stand (33). The support stand (33) can include a mast (34), a base (35), and a second support member (36). The mast (34) can have a length disposed between a mast first end (37) and a mast second end (38). The mast (34) can be coupled to the base (35) proximate the mast first end (37) and the yoke (10) can be coupled proximate the mast second end (38). The mast (34) can, but need not necessarily, be integral as one piece with the base (35).

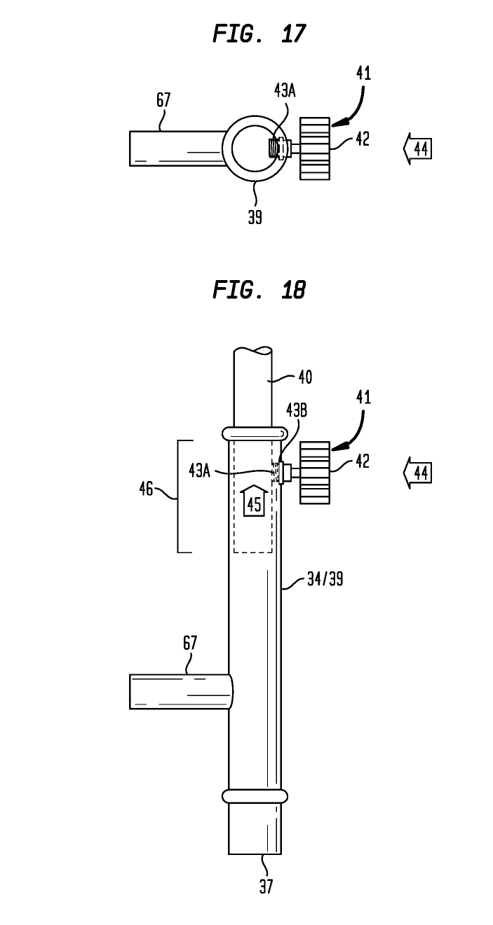

In particular embodiments, the mast (34) can include a mast first portion (39) telescopically coupled to a mast second portion (40) to vary the length of the mast (34). Referring primarily to the examples of FIGS. 9, 17, and 18, embodiments can include a height adjustment assembly (41) operable to hold the telescoping members (39)(40) at various positions of relative length. As shown in the illustrative example of FIGS. 17 and 18, the height adjustment assembly (41) can include a threaded member (43A) matingly engaged in a threaded aperture (43B)(show in the examples of FIGS. 17 and 18) disposed in the mast first portion (39) which forcibly presses upon the mast second portion (40) to maintain the telescoping members (39)(40) in fixed relation. A handle (42) can be coupled to the threaded member (43) to assist in rotating the threaded member (43) in either a clockwise or counterclockwise to increase or decrease the pressure (44) of the threaded member (43) against the mast second portion (40) to fix the position of overlapping portion (46)(as shown in the example of FIG. 18) of the mast first portion (39) and mast second portion (40). However, this example is not intended to preclude other configurations of the height adjustment assembly (41).

In particular embodiments, the height adjustment assembly (41) can be a screw cap disposed on the mast first portion (39), where the mast second portion (40) inserts through the screw cap. The inner peripheral margin of the screw cap can be frictionally engaged to the mast second portion (40). The friction between the inner peripheral margin and the mast second portion (40) can be increased or decreased by rotating the screw cap clockwise or counterclockwise.

As to other particular embodiments, the mast second portion (40) can have one or more linearly disposed aperture elements, and the mast first portion (39) can have a single aperture element, wherein the one or more linearly disposed aperture elements on the mast second portion (40) can axially align with the single aperture element of the mast first portion (39). A pin element can be coupled to the mast first portion (39), where the pin element passes through the single aperture element of the mast first portion (39) and one of the one or more linearly disposed aperture elements on the mast second portion (40).

Again, referring primarily to FIGS. 9 through 27, the base (35) can be comprise a plurality of leg members (48) radially outwardly extending about the longitudinal axis of the mast first end (37). Each of the plurality of leg members (48) can be configured to have a length disposed between a leg member first end (49) and a leg member second end (50) where each of the leg member first ends (49) can be disposed proximate the centerpoint (51) of the base (35). The leg member second ends (50) can be arranged about the centerpoint (51) of the base (35) in generally equiangular relation which maintains the mast (10) in an upright position (52) in relation to a support surface (47). The illustrative example of FIG. 9, includes three leg members in a tripod configuration (53). Additional configurations for particular embodiments can include four leg members configured as quadruped, or even a greater number of leg members. The leg members can comprise square, rectangular or circular solids or tubes which comprise or consist of: metal, metal alloys, wood, polymeric material, plastic, acrylic, polyamide, polyester, polypropylene, polyvinyl chloride, silicone-based materials, or the like, or combinations thereof.

Again referring primarily to FIGS. 9 through 27, the leg members (48) can, but need not necessarily, include end caps (54) disposed on each of the leg member second ends (50). The end caps (54) can be, but need not necessarily, be configured as closed end tubular conduits having one open end for accepting a corresponding one of the plurality of leg member second ends (50), or as to certain embodiments, the leg member second ends (5) can terminate in leg pads, or other like configuration. The end caps (54) or leg pads can comprise or consist of: felt, rubber, plastic, or other like pliant materials. The above examples of the base (35) are not intended to preclude other configurations of the base (35) which as an example can be configured as a one piece having a generally flat bottom surface configured to engage the support surface (47).

Now referring primarily to FIGS. 9 through 16, and 19 through 24, particular embodiments can further include a second support member (36) coupled to the mast (34) between the mast first end (37) and the mast second end (38). The second support member (36) can, but need not necessarily be configured to dispose a second support member first end (55) a distance from a second support member second end (56).

The second support member (36) can include a first portion (36A) disposed between outwardly extending second and third portions (36B)(36C) which correspondingly terminate in the second support member first end (55) and the second support member second end (56). The first portion (36A) can include any of a wide variety of configurations including as examples: a linear configuration or an arcuate configuration, or combination thereof, from which the second and third portions (36B)(36C) can outwardly extend to provide support for an object (21), such as, a musical instrument (as shown in the example of FIG. 27, a guitar base (89)). Further, the second support member first end (55) can be symmetrically opposite the second support member second end (56).

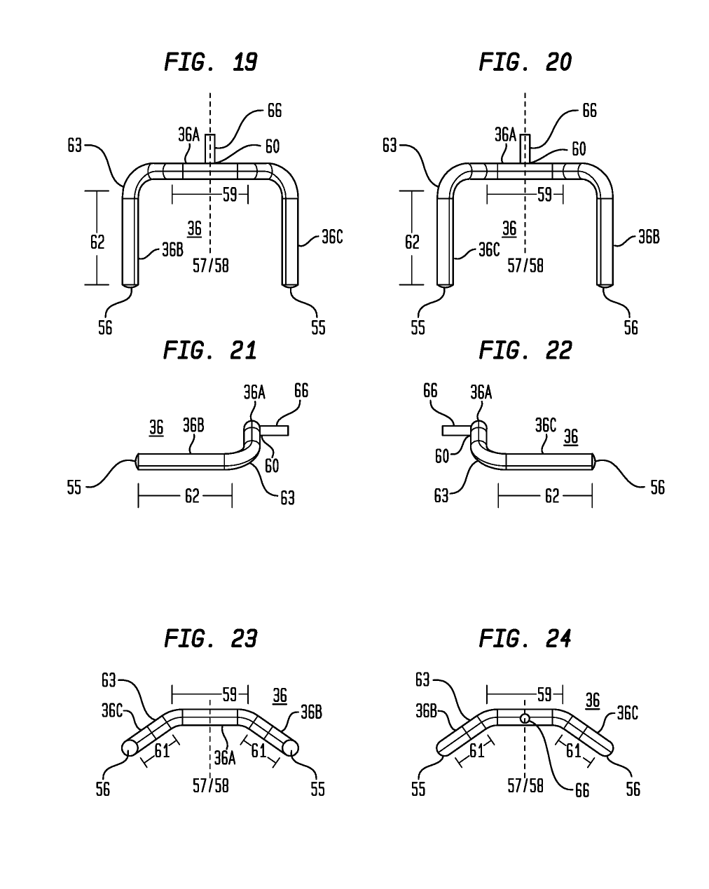

As illustrated in FIGS. 19, 20, 23, and 24, the second support member (36) can have bilateral symmetry (57), where the second support member first end (55) and second support member second end (56) comprise mirror images (58) of the other. Further, the second support member (36) can generally be configured to have a first portion (36A) including a first length (59) extending in opposite directions from a coupling junction (60)(as shown in the example of FIGS. 19 and 20), extend for a second length (61) at a generally downward angle from the first length (59)(as shown in the example of FIGS. 23 and 24), and have the second and third portions (36B)(36C) extend a third length (62) generally orthogonally and horizontally from the second length (61), where both the second support member first end (55) and second support member second end (56) extend in generally the same direction.

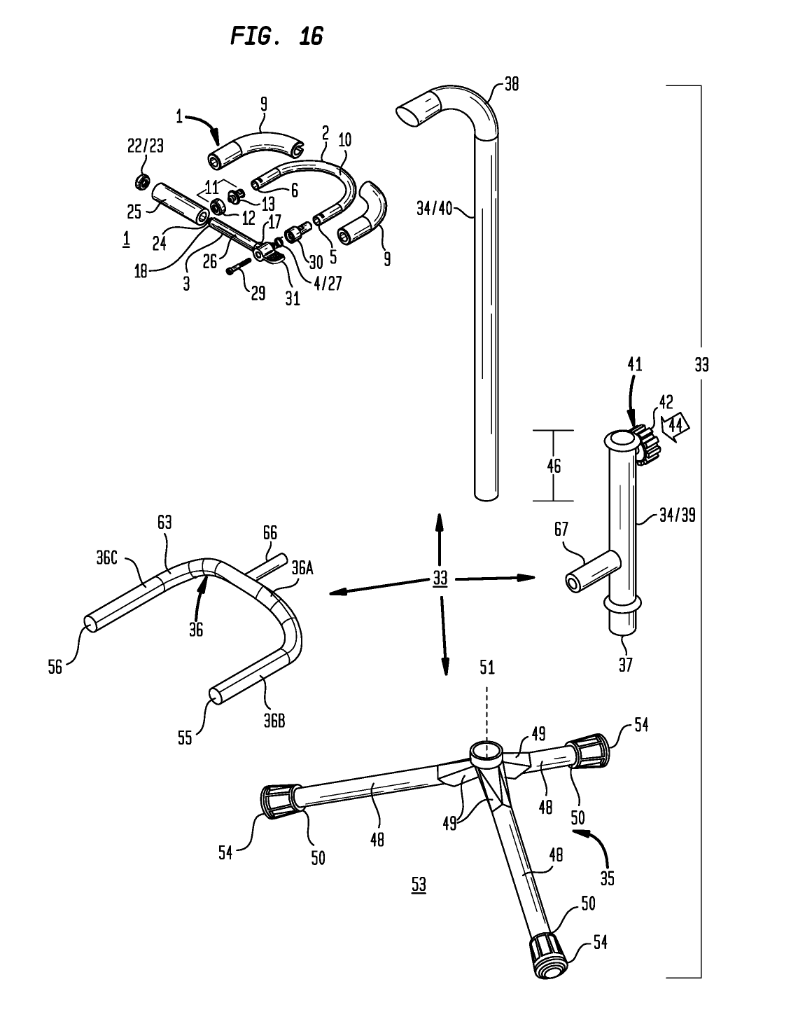

The second support member (36) can be coupled between the mast first and second ends (37)(38). As to particular embodiments, the second support member first portion (36A) can be directly connected onto the mast (34), by welding, adhesive, mechanical fasteners, or the like. Further, particular embodiments can include one or more additional coupling components (60) disposed between the second support member (36) and the mast (34)(as shown in the examples of FIGS. 9 and 16). A first coupling element (64) can be disposed on the mast (34) and configured to matingly engage a second coupling element (65) disposed on the second support member (36). In the particular embodiment shown in FIGS. 9 and 16, the first coupling element (64) comprises a female connector (66) which couples to the second coupling element (65), a male connector (67), by insertion of the second coupling element (65).

The second support member (36), first coupling element (64), and second coupling element (65) can be configured as a solid cylinder, tubular cylinder, solid bar, tubular bar, or other like configuration. By way of non-limiting examples, the material comprising the second support member (36), first coupling element (64), and second coupling element (65) can include or consist of: metal, metal alloys, wood, polymeric material, plastic, plastic-like material, acrylic, polyamide, polyester, polypropylene, polyvinyl chloride-based materials, silicone-based materials, or the like, or combinations thereof. A second member support pad (63) can be removably coupled to the second support member (36), surround the second support member (36), be permanently coupled to the second support member (36), coupled to a portion of the second support member (36), or be configured as a sleeve coupled in portions to the length of the second support member (36) coupled to the second support member can be comprised of foam, plastic, viscoelastic polymer, or other like material.

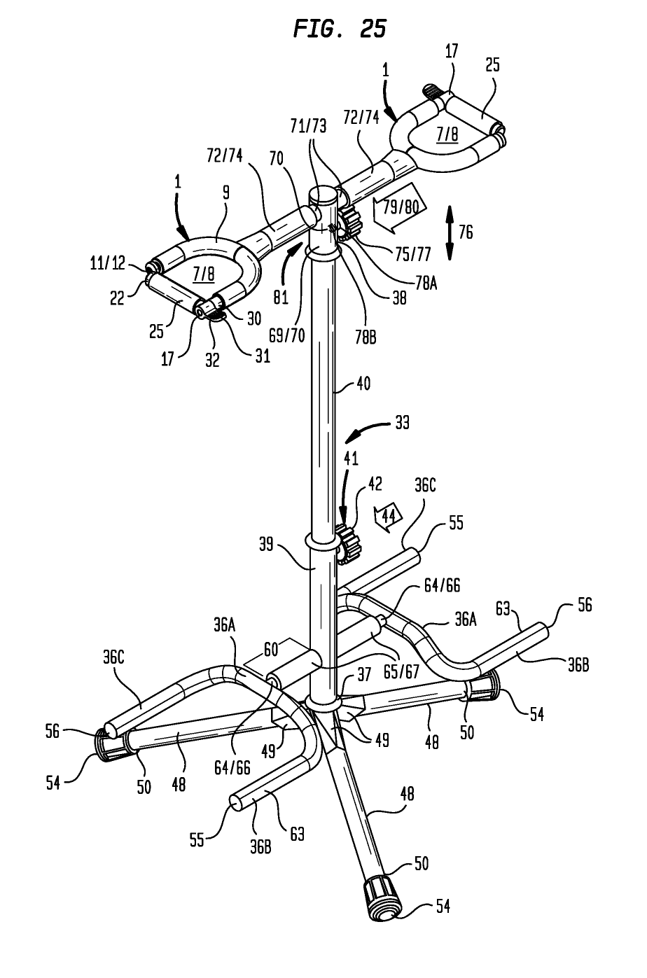

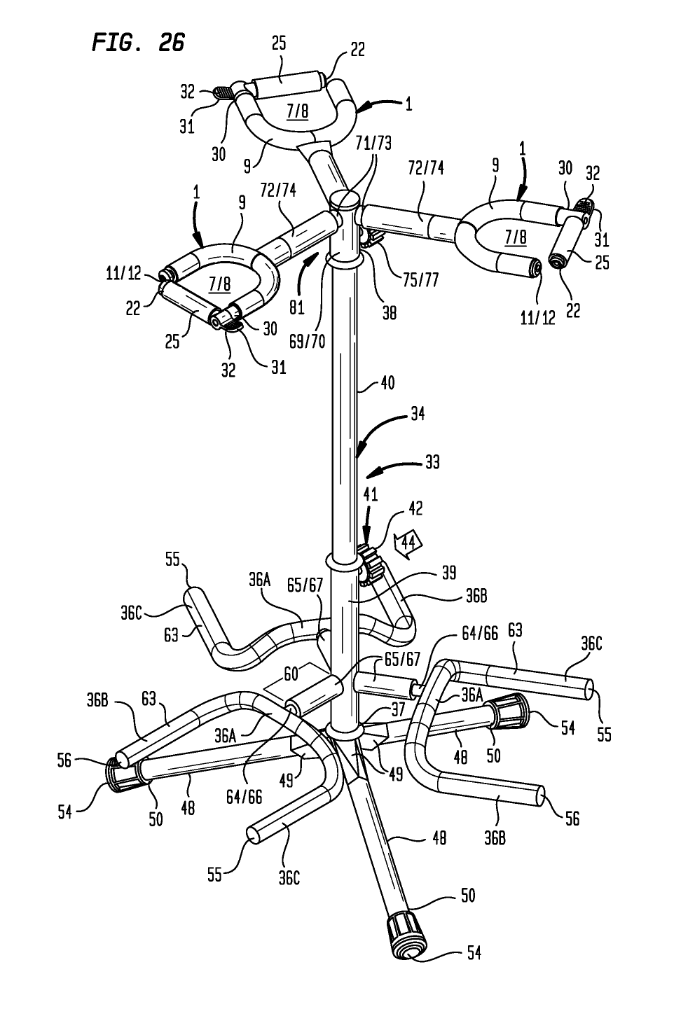

Now referring primarily to FIGS. 25 and 26, particular embodiments can further include a plurality of yokes (1) coupled between the mast first end (37) and the mast second end (38) or proximate the mast second end (38). Particular embodiments can further include a mast terminal (69) which removably couples to the mast second end (38). The mast terminal (69) can comprise a terminal sleeve (70) configured as a tubular conduit which removably receives the mast second end (38). A plurality of radial supports (71) can extend from the terminal sleeve (70). One of the plurality of yokes (1) can be correspondingly coupled to one of a plurality of radial support receiving elements (72) configured to correspondingly receive one of the plurality of radial supports (71) extending from the terminal sleeve (70). The terminal sleeve (70) can, but need not necessarily, further include an anti-rotation assembly (75) capable of resisting rotation of the mast terminal (69) in relation to mast second end (38). As to particular embodiments, the anti-rotation assembly (75) can comprise a handle (77) coupled to a threaded member (78A) matingly engaged in a threaded aperture (78B) disposed in the mast terminal (69) and upon rotation forcibly presses upon the mast second end (38) to dispose the mast terminal (69) in fixed relation to the mast second end (38). The handle (77) can be rotated in either a clockwise or counterclockwise to correspondingly increase or decrease the pressure (79) and friction (80) of the threaded member (78) against the mast second end (38) to maintain or alter the overlapping portion (81) of the mast terminal (69) and the mast second end (38) or to resist rotation of the mast terminal (69) about the mast second end (38). The mast terminal (69) can comprise or consist of: metal, metal alloys, wood, polymeric material, plastic, plastic-like material, acrylic, polyamide, polyester, polypropylene, polyvinyl chloride-based materials, silicone-based materials, or the like, or combinations thereof.

Now referring primarily to FIG. 27, a method of using a yolk (1) can include one or more of: obtaining a yoke (1), as described above, forcibly urging (83) the arm (3) to move away from the first arm position (19), removably disposing (84) an object within the enclosed interior (8) of the support member (2), and releasing (85) the arm (3) from forcible urging (83) to allow the arm (3) to return toward the first arm position (19).

In the particular embodiment of FIG. 27, the method further includes coupling a yoke (1) to a support stand (33). Forcible urging (83) of the arm (3) to move away from the first arm position (19), disposing an object, such as a guitar neck (87) within the enclosed interior (8) of the support member (2). The pressure (86) of forcible urging on the lever (31) can be removed and the arm (3) released to return toward (85) the first arm position (19). To remove the object (87), such as a guitar neck (87), from the enclosed interior (8) of the support member (2), pressure (86) by forcible urging (83), can be applied to the lever (31) coupled to the arm (3), to moves the arm (3) away from the first arm position (19. The object (87), such as a guitar neck (87), can be removed (84) from the enclosed interior (8) of the support member (2). The pressure (86) on the lever (31) can be removed which allows the arm (3) to be released (85) and return to the first arm position (19).

In other particular embodiments, the method of using a yoke (1) coupled to a support stand (33) can further include disposing the base (88) of the object (21) on the second support member (36) generally concurrent with disposing the object (21) within the enclosed interior (8) of the support member (2). In further particular embodiments having a plurality of yokes (68) coupled to a support stand (33), a corresponding plurality of objects (89) can be removable disposed within the enclosed interior (8) of a corresponding one of each of the plurality of yokes (68) for a support stand (33). In still further particular embodiments having a plurality of yokes (68) for a support stand (33) and a plurality of second support members (36), a corresponding base (68) of each of the plurality of objects (89) may be removably disposed on a corresponding one of each of the plurality of second support members (36) generally concurrently with removably disposing (84) the object within the enclosed interior (8) of a corresponding one of each of the plurality of yokes (68) for a support stand (33).

In yet further particular embodiments, a method of using a yoke (1) for a support stand (33) may include adjusting the length (90) of the mast (34) disposed between the mast first end (37) and the mast second end (38), as described previously.

As can be easily understood from the foregoing, the basic concepts of the present invention may be embodied in a variety of ways. The invention involves numerous and varied embodiments of a yoke (1) for a support stand (33) and methods for making and using a yoke (1) for a support stand (33) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “support” and even a “means for supporting.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the yokes for a support stand herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A yoke for a support stand, comprising:
a first support member configured to dispose a support member first end a distance from a support member second end;
an arm having an arm first end rotatably coupled to said support member first end and an arm second end rotationally positionable to a first arm position in which said arm extends at least part of said distance between said support member first end and said support member second end; and
a springing element coupled between said support member first end and said arm first end.

2. The yoke of claim 1, wherein said arm rotationally responsive to said springing element to move said arm toward said first arm position.

3. The yoke of claim 2, wherein said arm rotationally responsive to forcible urging to move away from said first arm position.

4. The yoke of claim 1, further comprising:
a mast having a length disposed between a mast first end and a mast second end;
a base coupled proximate said mast first end, said base configured to engage a support surface to support said mast in an upright position in relation to said support surface, said first support member coupled proximate said mast second end; and
a second support member coupled between said base and said first support member, said second support member configured to dispose a second support member first end a distance from a second support member second end.

5. The yoke of claim 4, wherein said first support member is selected from the group consisting of a linear configuration, an arcuate configuration, or combination thereof.

6. The yoke of claim 5, wherein said first support member comprises a second portion and a third portion each outwardly extending to define a recess.

7. The yoke of claim 6, wherein said second portion and said third portion each outwardly extending to define an interior space.

8. The yoke of claim 7, wherein said second portion and said third portion each outwardly extending to receive at least a portion of a musical instrument.

9. The yoke of claim 8, wherein said musical instrument comprises a guitar-shaped musical instrument.

10. The yoke of claim 9, wherein said guitar-shaped musical instrument comprises a guitar.

11. The yoke of claim 4, wherein said first support member is selected from the group consisting of solid metal, tubular metal, metal alloys, polymeric material, plastic, plastic-like material, acrylic, polyamide, polyester, polypropylene, polyvinyl chloride, silicone-based materials, wood, or combinations thereof.

12. The yoke of claim 1, wherein said first support member comprises a support member pad coupled to said first support member.

13. The yoke of claim 12, wherein said support member pad removably coupled to said first support member.

14. The yoke of claim 13, wherein said support member to completely surround an exterior surface of said first support member.

15. The yoke of claim 14, wherein said support member pad coupled to a portion of said first support member.

16. The yoke of claim 15, wherein said support member pad configured as a sleeve coupled in portions to a length of said first support member.

17. The yoke of claim 16, wherein said support member pad is selected from the group consisting of foam, plastic, viscoelastic polymer, pliable, or pliant materials.

18-37. (canceled)
